(19) United States
(12) Patent Application Publication
(10) Pub. No.: US 2016/0049099 A1
(43) Pub. Date: Feb. 18, 2016

(54) GARMENT USE TRACKER

(71) Applicant: Holly Prabhu, Stevenson Ranch, CA (US)

(72) Inventor: Holly Prabhu, Stevenson Ranch, CA (US)

(21) Appl. No.: 14/460,784

(22) Filed: Aug. 15, 2014

(51) Int. Cl. G09F 3/02

(52) U.S. Cl. CPC G09F 3/02; G09F 2003/0222; G09F 2003/0282

(57) ABSTRACT

A tracking device for tracking the number of times a garment has been worn. The device comprises an elongated body, a plurality of manually frangible elements on the elongated body, and adhesive on the elongated body, for adhering to the garment. Each of the frangible elements may comprise a bubble which flattens when burst. The frangible elements are linearly arrayed in a single row along the body. The body is vacuum formed from a synthetic resin and is die cut. The tracking device may be commercially provided as an assembly of separable tracking devices secured parallel to other tracking devices, with a frangible seam separating each two adjacent tracking devices.

### FIELD OF THE INVENTION

The present invention relates to an indicator for tracking and indicating the number of times a garment has been worn.

### BACKGROUND OF THE INVENTION

Many garments are worn and removed for a subsequent wearing. Many times, there is no need to launder these garments. Each garment may be worn a subsequent time after one or two weeks, or more. It becomes difficult for a person to keep track of how many times a garment has been worn. It is potentially important to know this, since some garments are delicate, and cannot withstand being laundered after each usage. Some garments, for example, may bear a manufacturer's recommendation to launder each five wearings. As the number of garments being tracked for the number of wearings increases, and as time between wearings of each garment passes, it becomes nearly impossible to launder garments at recommended intervals.

### SUMMARY OF THE INVENTION

The present invention addresses the above stated situation by providing a device discretely carried with the garment, which can track and indicate the number of times its associated garment has been worn.

In one implementation of the invention, the device comprises a band attachable to the garment, having frangible elements one of which is broken, ruptured, or removed after each wearing. The user may tell at a glance how many times that garment has been worn merely by observing the number of remaining undamaged frangible elements.

The device itself is sized, shaped, and colored so as to be inconspicuous, and may remain attached to the garment from a first wearing to a last wearing prior to laundering. For example, the device may comprise a band which encircles an element of the garment and is maintained in engagement by adhesive. When the final frangible element, or a predetermined number of frangible elements has been intentionally damaged to signal a wearing, the device is removed and discarded, and the garment may be laundered.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a top perspective view of a tracking device according to one aspect of the disclosure;

FIG. 2 is a detail view of a bubble typical of several formed along the tracking device of FIG. 1; and

FIG. 3 is a top perspective view of an assembly of separable tracking devices of the type shown in FIG. 1.

### DETAILED DESCRIPTION

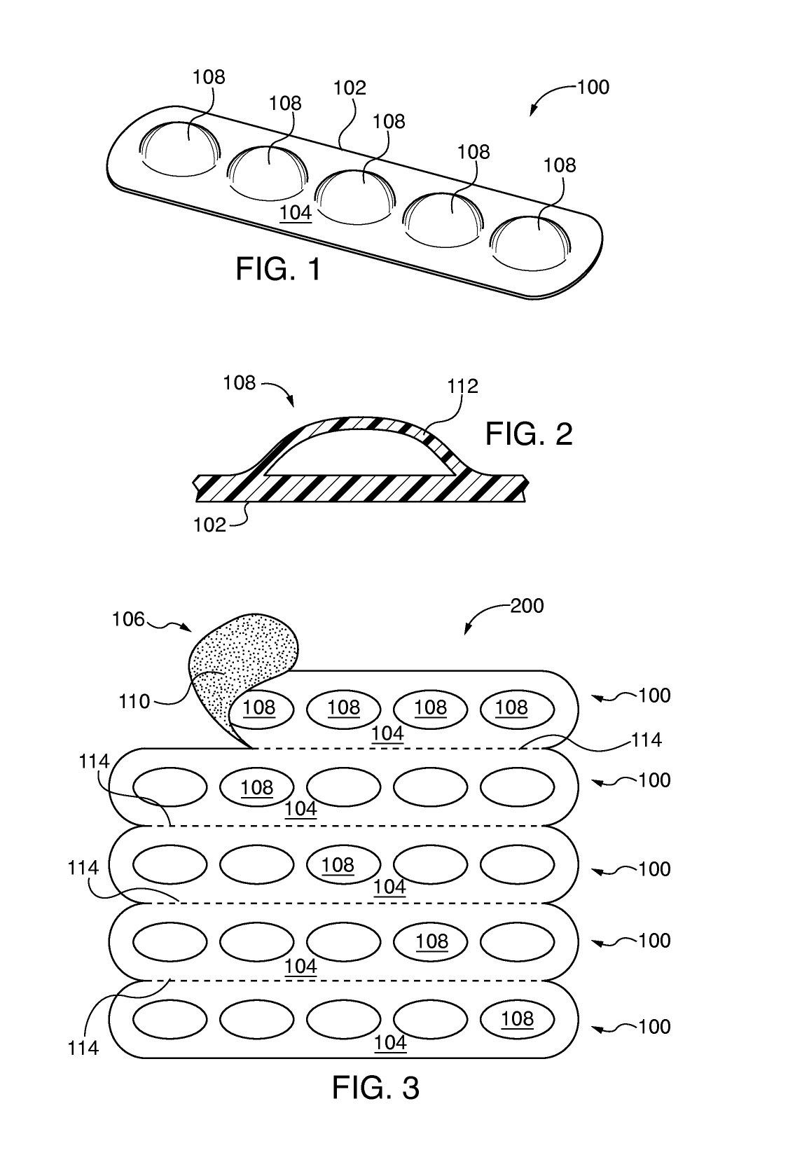

Referring first to FIG. 1, according to at least one aspect of the invention, there is shown a tracking device 100 for tracking the number of times a garment (not shown) has been worn. The tracking device 100 comprises an elongated body 102 having an obverse side 104 and a reverse side 106 (see FIG. 2). A plurality of manually frangible elements such as bubbles 108 is located on the obverse side 104 of the elongated body 102. As seen in FIG. 1, the frangible elements are linearly arrayed in a single row along the elongated body 102 of the tracking device 100.

As used herein, “bubble” refers to a construction of the elongated body 102 wherein an upper stratum 112 forms a dome or other structure which bulges away from the elongated body 102 of the tracking device 100 in an intact condition, with, for example, air entrapped between the upper stratum 112 and the elongated body 102. The dome or other bulging structure is readily burst by finger pressure. After the garment has been worn, one of the domes is manually burst. The dome then flattens and does not bulge away from the elongated body 102 when burst.

The user notes the number of burst domes, and when the number of burst domes equals the maximum number of times the garment is to be worn between launderings, the garment may then be laundered.

In the implementation depicted in FIGS. 1 and 3, there are five manually frangible elements on the elongated body 102. This number of manually frangible elements correlates to a frequently encountered number of wearings recommended by garment manufacturers. However, more or fewer manually frangible elements could be provided if desired. For example, a single tracking device 100 could have ten manually frangible elements. The garment could be laundered after for example five of the manually frangible elements have been burst, and laundered again after the final five manually frangible elements have been burst. However, where the manually frangible elements are very delicate, such that they might be burst when laundered, it may be preferable to limit the number of frangible elements to that indicating a maximum number of recommended wearings between launderings.

Adhesive 110 is located on the reverse side 106 of the elongated body 102. The adhesive 110 enables the elongated body 102 to engage and adhere to a portion of the garment. Each tracking device 100 may be mounted in an inconspicuous location on the garment, and left mounted on the garment until it is time for laundering.

The elongated body 102 of the tracking device 100 may be vacuum formed from a synthetic resin. The domes may be formed in any suitable way enabling manual bursting of the bubbles 108.

FIG. 3 shows an assembly 200 of separable tracking devices 100. Each individual tracking device 100 is secured to at least one other tracking device 100 along a frangible seam 114. The frangible seam 114 may be formed by scoring or perforating the constituent material of the elongated body 102.

The assembly 200 is regarded as an advantageous way to provide the tracking devices for retail purposes. A number of separate tracking devices 100 may be fabricated, packaged, and sold en masse to a retail customer.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A tracking device for tracking the number of times a garment has been worn, the device comprising an elongated body having an obverse side and a reverse side, a plurality of manually frangible elements on the obverse side of the elongated body, and adhesive on the reverse side of the elongated body, for enabling the elongated body to engage a portion of the garment.

2. The tracking device of claim 1, wherein each one of the frangible elements comprises a bubble which bulges away from the elongated body of the tracking device when intact, and which flattens and does not bulge away from the elongated body when burst.

3. The tracking device of claim 2, wherein the frangible elements are linearly arrayed in a single row along the elongated body of the tracking device.

4. The tracking device of claim 3, wherein there are five manually frangible elements on the elongated body.

5. The tracking device of claim 1, wherein the elongated body of the tracking device is vacuum formed from a synthetic resin.

6. An assembly of separable tracking devices for tracking the number of times a garment has been worn, wherein
each said device comprises an elongated body, a plurality of manually frangible elements on the elongated body, and adhesive on the elongated body, for enabling the elongated body to engage a portion of the garment, and
each said elongated body is secured to at least one other elongated body along a frangible seam.
